(19) United States
(12) Patent Application Publication
(10) Pub. No.: US 2011/0249328 A1
(43) Pub. Date: Oct. 13, 2011

(54) DOBSONIAN TELESCOPE APPARATUS, AND METHODS OF MAKING AND USING SAME

(76) Inventor: RANDALL MISIAK, Ossineke, MI (US)

(21) Appl. No.: 12/759,384

(22) Filed: Apr. 13, 2010

(51) Int. Cl. G02B 23/16

(52) U.S. Cl. 359/430

(57) ABSTRACT

A Dobsonian telescope apparatus having a first motor for rotating the telescope about a first axis, a second motor for rotating the optical tube assembly about a second axis, and a handheld control device. The first and second axes are perpendicular to each other. The apparatus avoids the erratic manual nudging by the user needed to align a conventional Dobsonian telescope.

The present invention relates generally to a Dobsonian telescope apparatus, and methods of making and using same.

More particularly, the present invention relates to a Dobsonian telescope apparatus which avoids the erratic manual nudging by the user needed to align the telescope tube, and methods of making and using same.

### BACKGROUND OF THE INVENTION

A Dobsonian telescope is an alt-azimuth mounted newtonian telescope design popularized by the amateur astronomer John Dobson starting in the 1960s.

Dobson's telescopes feature a simplified mechanical design that is easy to manufacture from readily available components to create a large, portable, low-cost telescope.

The design is intended for visually observing faint objects, a requirement where the observer needs a large objective diameter (i.e. light-gathering power) combined with portability for travel to non-light polluted locations.

The Dobsonian telescope is intended to be what is generally called a “light bucket” operating at low magnification, and therefore the design omits features found in other amateur telescopes such as equatorial tracking.

The Dobsonian telescope is popular in the amateur telescope making community, where the design was pioneered and continues to evolve.

Sighting or alignment of conventional Dobsonian telescopes necessarily involves erratic manual nudging by the user needed to align the telescope tube.

It is a desideratum of the present invention to provide novel and unique Dobsonian telescope apparatus which avoids the animadversions of the prior art and conventional telescopes.

### SUMMARY OF THE INVENTION

The present invention provides a Dobsonian telescope apparatus, comprising: a Dobsonian telescope; first means for electromechanically rotating said telescope about a first axis; second means for electromechanically rotating an optical tube assembly of said telescope about a second axis; said first axis and said second axis being arranged mutually perpendicular relative to each other; and a control device having a first switch for controlling said first means, and a second switch for controlling said second means.

An object of the invention is to provide a Dobsonian telescope apparatus as described hereinabove wherein the invention avoids the erratic manual nudging by the user needed to align the telescope tube, by providing the user with a handheld motor control box having: a first pushbutton switch that controls a first drive motor that smoothly rotates the telescope mount via a planetary drive 360 degrees (or any desired number of degrees) in a horizontal plane; and a second pushbutton switch that controls a second drive motor that smoothly moves the telescope tube in a vertical plane by moving a rod attached to the telescope tube at the lower portion of the mid-section of the telescope tube.

A further object of the invention is to provide a Dobsonian telescope apparatus as described hereinabove wherein said control device is portable and can be handheld by a user of said apparatus.

Another object of the invention is to provide a Dobsonian telescope apparatus as described hereinabove wherein said first means includes a planetary gear mechanism driven by a first motor.

A further object of the invention is to provide a Dobsonian telescope apparatus as described hereinabove wherein said second means includes a rotatable threaded rod driven by a second motor.

Another object of the invention is to provide a Dobsonian telescope apparatus as described hereinabove wherein said first means includes a sun gear fastened to a stationary lower disc, and a planetary gear which meshes with said sun gear.

Another object of the invention is to provide a Dobsonian telescope apparatus as described hereinabove wherein: said second means includes a drive belt which connects said second motor to a pulley attached to a shaft that is connected to said rotatable threaded rod; there is provided a tube having threaded nut affixed thereto; and said threaded nut is threaded onto said rotatable threaded rod to allow said second motor to control movement of said optical tube assembly of said telescope for electromechanically rotating said optical tube assembly of said telescope about said second axis.

A further object of the invention is to provide a Dobsonian telescope apparatus as described hereinabove having a planetary drive telescope mount.

A further object of the invention is to provide a Dobsonian telescope apparatus as described hereinabove which provides automatic or motor-driven altitude and azimuth movements of the Dobsonian telescope mount.

Further objects, advantages and features of the present invention will become apparent to those persons skilled in this particular area of technology and to others after being exposed to the following detailed specification and accompanying drawings.

### BRIEF DESCRIPTION OF THE DRAWINGS

FIG. 1 is a side elevational view of a Dobsonian telescope apparatus in accordance with a first embodiment of the present invention.

FIG. 2 is a front view of the FIG. 1 embodiment.

FIG. 3 is view of the mechanism for smoothly moving the telescope tube in a vertical plane.

FIG. 4 illustrates a vertical elevational view of the lower half of FIG. 2.

FIG. 5 is a view of the mechanism for smoothly rotating the telescope mount via a planetary drive 360 degrees (or any desired number of degrees) in a horizontal plane.

FIG. 6 depicts a top view of the lower disc of the apparatus.

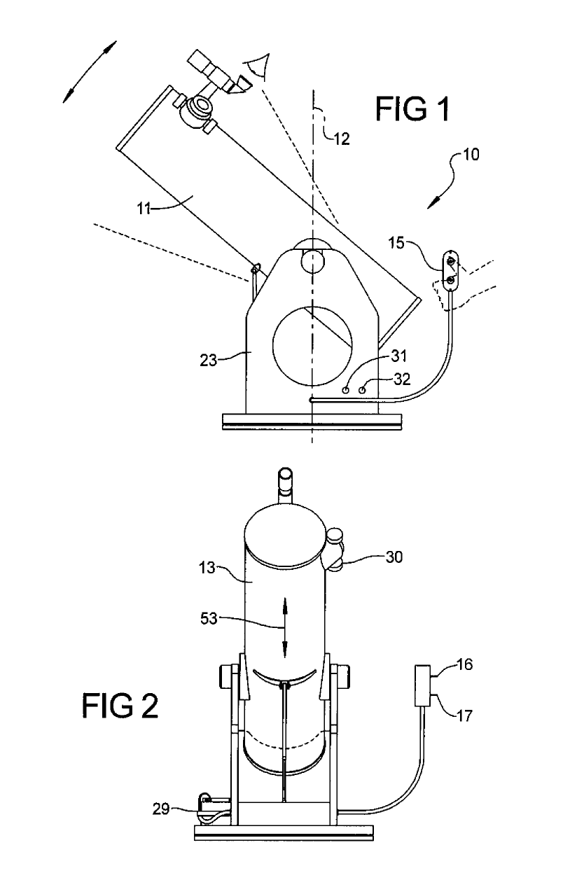

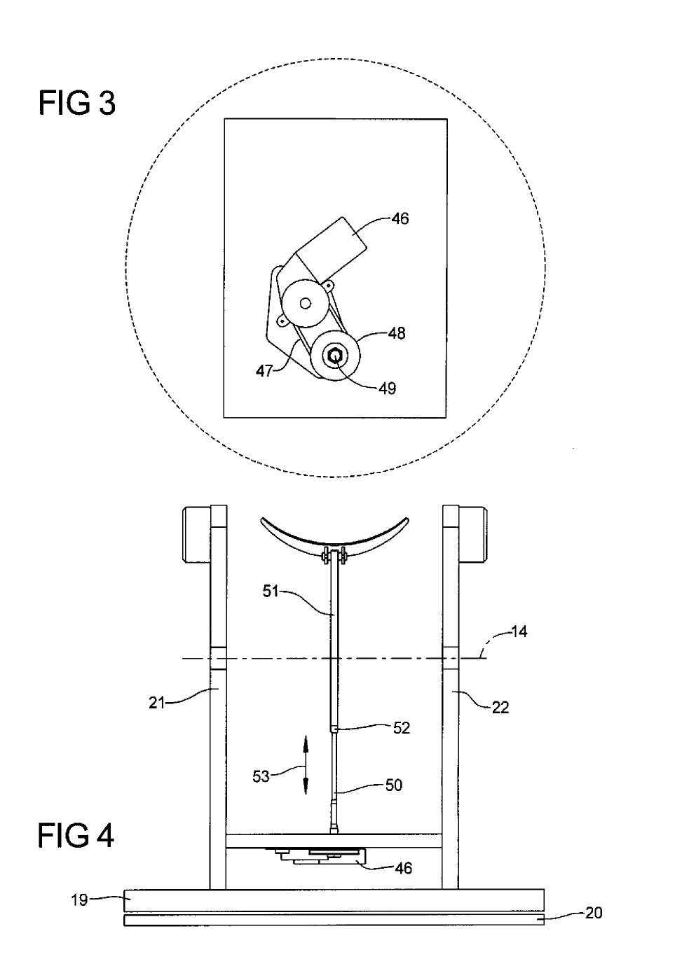

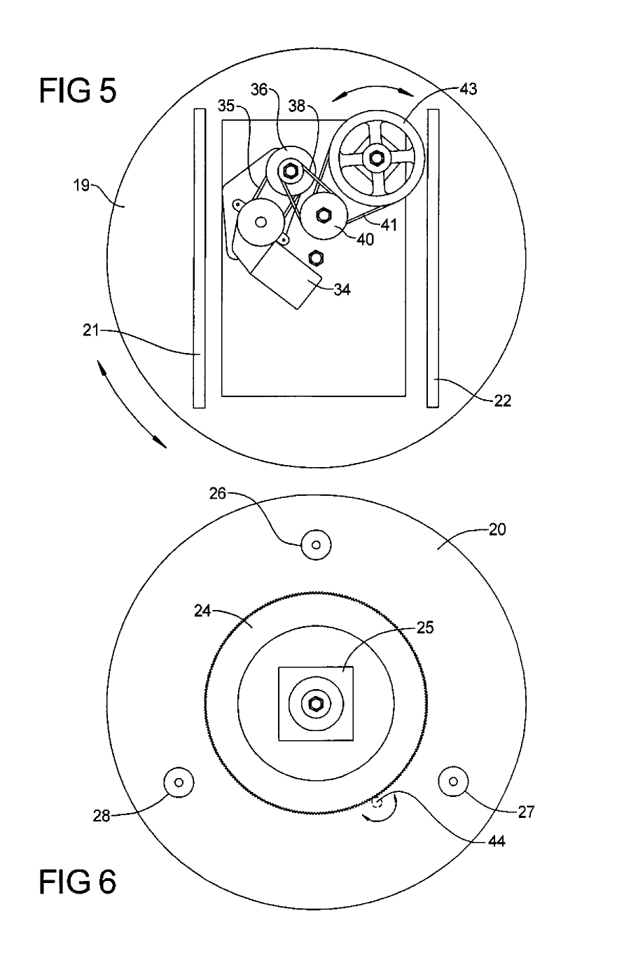

### DETAILED DESCRIPTION OF SOME PREFERRED EMBODIMENTS OF THE PRESENT INVENTION

With reference to the drawings, there is shown a Dobsonian telescope apparatus 10, comprising: a Dobsonian telescope 11; first means for electromechanically rotating said telescope 11 about a first axis 12; second means for electromechanically rotating an optical tube assembly 13 of said telescope 11 about a second axis 14; said first axis 12 and said second axis 14 being arranged mutually perpendicular relative to each other; and a control device 15 having a first switch 16 for controlling said first means, and a second switch 17 for controlling said second means.

The apparatus 10 includes a Dobsonian telescope base 18 having two discs 19 and 20, two side members 21 and 22, and a front member 23 to support the optical tube assembly 13.

The base materials consist of any suitable materials, such as, for example, plywood and/or formica.

Between the two discs 19 and 20, a 13″ sun gear 24 is fixed to the lower disc 20.

A 6″ lazy susan bearing 25 is fixed inside sun gear 24.

Three teflon pads 26, 27 and 28 are also fastened to the lower disc 20, to aid in stability and smoothness of motion.

A 12-volt battery 29 is placed on the top disc 19, against the side member 21, opposite the eyepiece 30.

Electrical power is then run to a rotary switch 31 (Off, High, Medium, and Low), as well as an accessory jack 32, which is used to run an acclimatizing fan motor 33 on the optical tube assembly 13.

Electrical power from the rotary switch 31 is run to the two momentary switches 16 and 17 in the handheld controller 15.

One switch 16 in the handheld controller 15 operates the azimuth movement (clockwise and counterclockwise).

The other switch 17 operates the altitude movement (up and down, as indicated by the double arrow 53).

Electric power from the azimuth switch 16 is then run to a 12-volt electric, reversible gear reduction motor 34.

A drive belt 35 attaches the gear reduction motor 34 to a first pulley 36, with a smaller second pulley welded to its top.

Another drive belt 38 goes from this smaller pulley to a third pulley with a fourth pulley 40 welded to its bottom.

From this fourth pulley 40 a belt 41 attaches to a fifth pulley 43, which in turn is attached to a planetary gear 44.

This planetary gear 44 fits through a hole in the top disc 19, to allow meshing with the sun gear 24 fastened to the lower disc 20. It is this combination, the planetary gear 44 orbiting the sun gear 24, which achieves the azimuth movement.

Electrical power from the altitude switch 17 is run to a second 12-volt reversible, gear reduction motor 46.

A drive belt 47 connects the motor 46 to a sixth pulley 48 attached to a shaft 49, which is connected to a threaded rod 50.

A steel tube 51 with a nut 52 welded in its end is then screwed onto the threaded rod 50. This combination allows the electric motor 46 to control up and down movement of the optical tube assembly 13.

The apparatus 10 avoids the erratic manual nudging by the user needed to align the telescope tube 13, by providing the user with a handheld motor control box 15 having: the first pushbutton switch 16 that controls the first drive motor 34 which smoothly rotates the telescope mount 18 via a planetary drive 360 degrees (or any desired number of degrees) in a horizontal plane; and the second pushbutton switch 17 that controls the second drive motor 46t which smoothly moves the telescope tube 13 in a vertical plane by moving the rod 50 attached to the telescope tube 13 at the lower portion of the mid-section of the telescope tube 13.

The control device 15 is portable and can be handheld by a user of the apparatus 10.

The first means includes the planetary gear 44 mechanism driven by the first motor 34.

The second means includes the rotatable threaded rod 50 driven by the second motor 46.

The first means includes the sun gear 24 fastened to the stationary lower disc 20, and the planetary gear 44 which meshes with the sun gear 24.

The second means includes a drive belt which connects the second motor 46 to the pulley attached to the shaft 51 that is connected to the rotatable threaded rod 50;

The tube 51 has the threaded nut 52 affixed thereto.

The threaded nut 52 is threaded onto the rotatable threaded rod 50 to allow the second motor 46 to control movement of the optical tube assembly 13 of the telescope 11 for electromechanically rotating the optical tube assembly 13 of the telescope 11 about the second axis 14.

While the present invention has been described in detail with reference to only one particular embodiments thereof, it should be understood that this has been described by way of illustration only, and not by way of limitation.

The present invention embraces all embodiments, modifications, variations and changes which come within the scope of the patent claims set forth hereinbelow.

1. A Dobsonian telescope apparatus, comprising:
a Dobsonian telescope;
first means for electromechanically rotating said telescope about a first axis;
second means for electromechanically rotating an optical tube assembly of said telescope about a second axis;
said first axis and said second axis being arranged mutually perpendicular relative to each other; and
a control device having a first switch for controlling said first means, and a second switch for controlling said second means.

2. The Dobsonian telescope apparatus of claim 1, wherein:
said control device is portable and can be handheld by a user of said apparatus.

3. The Dobsonian telescope apparatus of claim 1, wherein:
said first means includes a planetary gear mechanism driven by a first motor.

4. The Dobsonian telescope apparatus of claim 2, wherein:
said first means includes a planetary gear mechanism driven by a first motor.

5. The Dobsonian telescope apparatus of claim 1, wherein:
said second means includes a rotatable threaded rod driven by a second motor.

6. The Dobsonian telescope apparatus of claim 2, wherein:
said second means includes a rotatable threaded rod driven by a second motor.

7. The Dobsonian telescope apparatus of claim 3, wherein:
said second means includes a rotatable threaded rod driven by a second motor.

8. The Dobsonian telescope apparatus of claim 4, wherein:
said second means includes a rotatable threaded rod driven by a second motor.

9. The Dobsonian telescope apparatus of claim 1, wherein:
said first means includes a sun gear fastened to a stationary lower disc, and a planetary gear which meshes with said sun gear.

10. The Dobsonian telescope apparatus of claim 2, wherein:
said first means includes a sun gear fastened to a stationary lower disc, and a planetary gear which meshes with said sun gear.

11. The Dobsonian telescope apparatus of claim 3, wherein:
said first means includes a sun gear fastened to a stationary lower disc, and a planetary gear which meshes with said sun gear.

12. The Dobsonian telescope apparatus of claim 4, wherein:
said first means includes a sun gear fastened to a stationary lower disc, and a planetary gear which meshes with said sun gear.

13. The Dobsonian telescope apparatus of claim 5, wherein:
said first means includes a sun gear fastened to a stationary lower disc, and a planetary gear which meshes with said sun gear.

14. The Dobsonian telescope apparatus of claim 6, wherein:
said first means includes a sun gear fastened to a stationary lower disc, and a planetary gear which meshes with said sun gear.

15. The Dobsonian telescope apparatus of claim 7, wherein:
said first means includes a sun gear fastened to a stationary lower disc, and a planetary gear which meshes with said sun gear.

16. The Dobsonian telescope apparatus of claim 8, wherein:
said first means includes a sun gear fastened to a stationary lower disc, and a planetary gear which meshes with said sun gear.

17. The Dobsonian telescope apparatus of claim 5, wherein:
said second means includes a drive belt which connects said second motor to a pulley attached to a shaft that is connected to said rotatable threaded rod;
there is provided a tube having threaded nut affixed thereto; and
said threaded nut is threaded onto said rotatable threaded rod to allow said second motor to control movement of said optical tube assembly of said telescope for electromechanically rotating said optical tube assembly of said telescope about said second axis.

18. The Dobsonian telescope apparatus of claim 6, wherein:
said second means includes a drive belt which connects said second motor to a pulley attached to a shaft that is connected to said rotatable threaded rod;
there is provided a tube having threaded nut affixed thereto; and
said threaded nut is threaded onto said rotatable threaded rod to allow said second motor to control movement of said optical tube assembly of said telescope for electromechanically rotating said optical tube assembly of said telescope about said second axis.

19. The Dobsonian telescope apparatus of claim 7, wherein:
said second means includes a drive belt which connects said second motor to a pulley attached to a shaft that is connected to said rotatable threaded rod;
there is provided a tube having threaded nut affixed thereto; and
said threaded nut is threaded onto said rotatable threaded rod to allow said second motor to control movement of said optical tube assembly of said telescope for electromechanically rotating said optical tube assembly of said telescope about said second axis.

20. The Dobsonian telescope apparatus of claim 8, wherein:
said second means includes a drive belt which connects said second motor to a pulley attached to a shaft that is connected to said rotatable threaded rod;
there is provided a tube having threaded nut affixed thereto; and
said threaded nut is threaded onto said rotatable threaded rod to allow said second motor to control movement of said optical tube assembly of said telescope for electromechanically rotating said optical tube assembly of said telescope about said second axis.
